(19) United States
(12) Patent Application Publication
(10) Pub. No.: US 2015/0310489 A1
(43) Pub. Date: Oct. 29, 2015

(54) SELF SERVICE DIGITAL COUPON, DISCOUNT DEAL AND WEEKLY AD PUBLISHING AND MANAGEMENT METHOD

(71) Applicant: Mohammed F. Hussain, Troy, MI (US)

(72) Inventor: Mohammed F. Hussain, Troy, MI (US)

(21) Appl. No.: 14/792,455

(22) Filed: Jul. 6, 2015

Related U.S. Application Data
(63) Continuation-in-part of application No. 13/544,626, filed on Jul. 9, 2012, now abandoned.

(51) Int. Cl. G06Q 30/02

(52) U.S. Cl. CPC G06Q 30/0257; G06Q 30/0276

(57) ABSTRACT

A method of publishing and managing a self-service digital promotional advertisement, such as a coupon, a discount deal, or a weekly ad includes the steps of validating a user access and permitting entry to a publishing application, providing a pre-built digital promotional advertisement and template based on the user's access, inputting data for the promotional advertisement and template, submitting the promotional advertisement for publishing, publishing the promotional advertisement to a web site, and displaying the promotional advertisement for a user. A method of publishing a self-service digital promotional advertisement, such as a digital coupon, a discount deal, or a weekly ad includes the steps of visiting the web site, logging into the publishing application, selecting the promotional advertisement template, customizing the promotional advertisement template to form a user-edited promotional advertisement, submitting the user-edited promotional advertisement for publishing, processing the submission request, and publishing the user-edited promotional advertisement.

### CROSS-REFERENCE TO RELATED APPLICATION

The present application is a continuation-in-part of U.S. Utility patent application Ser. No. 13/544,626 filed on Jul. 9, 2012, entitled “Digital Self Service Coupon, Discount Deal and Weekly Ad Application Software Platform”, the entire disclosure of which is incorporated by reference herein.

### TECHNICAL FIELD OF THE INVENTION

The invention pertains to a method of digital coupon, weekly ad and discount deal creation and management in the field of digital advertising and publishing.

### BACKGROUND OF THE INVENTION

In today's digital advertising world, there is a wide variety of digital coupon, discount deal or weekly ad creation methods or processes available, using a variety of software applications or platforms. However, none of them provides a self-service creation and management method or process capability. Also, they are not fully automated for instantaneous creation, management and publishing to a web site or mobile application. All the existing solutions require manual steps as part of the process. Here is the typical method or process for the creation and management of digital coupon, discount deal and weekly ad solutions that currently exist.

Existing creation method or process:
1. Signup for the digital coupon, discount deal or weekly ads;
2. A digital coupon, discount deal or weekly ad image is manually created using publishing software;
3. The digital coupon, discount deal or weekly ad is submitted via email, ftp or web site upload;
4. A system operator validates the submitted file for proper formatting to conform to the system standard;
5. A system operator publishes the file to the digital coupon, discount deal or weekly ad web site or mobile application using the publishing tool.

Existing management method or process:
1. An existing digital coupon, discount deal or weekly ad image is manually edited or revised using publishing software;
2. The edited version of the digital coupon, discount deal or weekly ad is submitted via email, ftp or web site upload;
3. A system operator validates the submitted file for proper formatting to conform to the system standard;
4. A system operator removes and publishes the new file to the digital coupon, discount deal or weekly ad web site or mobile application using the publishing tool.

As described above, the method or process for existing solutions doesn't provide the automated or self-service functionality and requires multiple manual steps to create and manage digital coupons, discount deals and/or weekly ads and publish them to a web site. Also, the existing method or process requires multiple manual steps and users. Applying the existing method or process requires integration and conformance to multiple software applications, platforms and standards.

### SUMMARY OF THE INVENTION

The proposed invention is an end-to-end method or process for creating and managing digital promotional advertisements, such as digital coupons, discount deals or weekly ads, based on a self-service model by using standard web client and server technologies. The software application or platform built using the method or process as a design logic will provide end-to-end self-service creation, management and publishing capability to a digital advertising web site or mobile application.

The digital coupon, discount deal or weekly ad web server hosting the creation, management and web site consists of the following:
1. Setup a web server using any standard web hosting software that hosts the web site or mobile application;
2. Setup a database server for the web server;
3. Setup a database and define the pre-build templates fields on the database server for digital coupons, discount deals and weekly ads, with content fields that will be used for pre-built templates. The templates will be used for creation and update of the content by the user. The database can hold multiple pre-build templates. The number of available pre-built templates is determined by the web server operator. He or she will determine how many digital coupon, discount deal and weekly ad templates to make available to the users. All fields are defined based on what information is needed for each pre-built digital coupon, discount deal and weekly ad template;
4. Create a publishing software application to run on the web server, based on the pre-built template design fields in step 3, using any standard web development language (HTML, Java, PHP etc.);
5. Integrate the publishing software application with the web server and database server so it is accessible to a user when they access the web site or mobile application via a web browser.

The creation method or process for the self-service digital coupon, discount deal or weekly ad consists of the following:
1. User signup for the digital coupon, discount deal or weekly ad on a web site;
2. User logs in to the web site or mobile application to access the self-service digital coupon, discount deal or weekly ads software application;
3. User accesses the digital coupon, discount deal or weekly ad publishing software application, via a web browser, through the web site or mobile application. The web site or mobile application supplies the front end interface for the publishing software application;
4. User supplies the content of the digital coupon, discount deal or weekly ad based on the pre-defined template gallery fields defined in the software application database via their browser;
5. User supplies any custom graphics (such as company logos) or text (such as company name) for the customization fields defined in the software application database;
6. The self-service software application instantly creates and publishes the digital coupon, discount deal or weekly ad by processing the user defined content data;
7. After creation and publishing, the digital coupon, discount deal or weekly ad is immediately available on the internet via website or mobile application.

The management method or process for the self-service digital coupon, discount deal or weekly ad consists of the following:
1. User logs in to the web site or mobile application using any standard web browser client to access the self-service digital coupon, discount deal or weekly ad software application;
2. User accesses the existing published digital coupon, discount deal or weekly ad software application via web browser client;
3. User updates the content of the digital coupon, discount deal or weekly ad as desired, based on the pre-defined template gallery fields in the software application, via their web browser client;
4. User updates the customization graphics or text for customization fields, if desired;
5. The self-service digital coupon, discount deal or weekly ad software application instantly updates the information and/or image content submitted by the user, and publishes it to the web site or mobile application;
6. Once the updated content is submitted by the user and published by the web server, the updated digital coupon, discount deal or weekly ad is immediately available on the internet via website or mobile application.

The invention significantly reduces digital coupon, discount deal and weekly ad creation and management time by providing self-service and control to the user. A user no longer needs to create the digital coupon, discount deal or weekly ad manually using a separate publishing software. Submission of images via email, ftp or website upload is no longer required. The user does not need to develop a design for their coupon, discount deal or weekly ad, since the pre-built template is supplied by the publishing software application. Significant time is saved in the process, since there is no longer a need for the exchange, validation and approval of digital coupon, discount deal or weekly ad image proofs, required as part of the existing method or process. Eliminating the human exchange of digital coupon, discount deal and weekly ad proofs also provides significant cost savings, as well as eliminating problems arising from human error. All of these benefits also significantly reduce the cost of digital coupon, discount deal and weekly ad creation and management to make digital advertising affordable for all size businesses.

The invention method immediately shows the image proof to the user upon publishing. If any change or update is required to the digital coupon, discount deal or weekly ad image, the user can simply follow the above process again, submitting updated content via their web browser. The web server will process and publish the updates immediately.

The invention enables any user to create and manage their digital coupons, discount deals and weekly ads completely.

Below is the end-to-end method or process summary for the entire digital coupon, discount deal or weekly ad creation and management solution for the claims:
1. A web server is established to host the web site or mobile application for digital coupon, discount deal and weekly ad publishing software application;
2. A back end database server is established and integrated with the web server, mobile application and the digital coupon, discount deal and weekly ad publishing application;
3. Pre-built digital coupon, discount deal and weekly ad templates and fields are defined in the database for standard template content as well as customized content. The user will input content to these fields to generate the digital coupon, discount deal or weekly ad image instantly;
4. User signs up via their web browser by accessing the web site or mobile application to establish secure access;
5. User logs in to the web site or mobile application to access the individual account they signed up for;
6. User creates or updates the digital coupon, discount deal or weekly ad information and/or image by entering content for the standard and customized fields, then submits it via web browser;
7. The web server, publishing software application and database server process the user content submission and publish it to the web site or mobile application;
8. After the digital coupon, discount deal or weekly ad is published to the website, it is immediately available on the internet, via the web site or mobile application, as a digital advertisement image.

The web server referenced is a standard web server, using any standard web server software. The database server referenced is established using a Microsoft SQL, MySQL or Oracle server. The publishing software application referenced is a custom software, written in standard web development language and based on the supplied method or process.

A method of creating and publishing a self-service digital promotional advertisement, such as a digital coupon, a discount deal, or a weekly ad includes the steps of:
1. validating a user access and permitting entry to a publishing application;
2. providing a pre-built digital promotional advertisement and template based on the user's access;
3. the user inputting data for the promotional advertisement and template;
4. the user submitting the promotional advertisement for publishing;
5. the publishing application publishing the promotional advertisement to a web site; and
6. displaying the promotional advertisement for a user.

A method of managing and publishing a self-service digital promotional advertisement, such as a coupon, a discount deal, or a weekly ad includes the steps of:
1. visiting the web site;
2. logging into the publishing application;
3. selecting the published or existing digital coupon, discount deal or weekly ad;
4. customizing the digital coupon, discount deal or weekly ad with updated content;
5. submitting the user-edited digital coupon, discount deal or weekly ad for publishing;
6. the publishing application processing the submission request; and
7. publishing the updated digital coupon, discount deal and weekly ad

### BRIEF DESCRIPTION OF THE DRAWINGS

FIG. 1 shows the high level internal processing flow of the web server, publishing software and database server integration, according to an embodiment of the present invention;

FIG. 2 shows the end-to-end digital coupon, discount deal or weekly ad creation method, according to an embodiment of the present invention.

FIG. 3 shows the end-to-end digital coupon, discount deal or weekly ads management method, according to an embodiment of the invention.

FIG. 4 shows what is configured within the publishing software application on the web server for the digital coupon pre-build template gallery according to one embodiment of the present invention.

FIG. 5 shows what is configured within the publishing software application on the web server for the digital discount deal pre-built template gallery, according to an embodiment of the present invention.

FIG. 6 shows what is configured within the publishing software application on the web server for the digital weekly ad template gallery, according to an embodiment of the present invention.

### DETAILED DESCRIPTION OF PREFERRED EMBODIMENTS

The present invention provides a unique self-service or self-provisioning method for creating and managing digital coupons, weekly ads and discount deals and publishing them to a web site or mobile application for immediate delivery to the internet audience. The method or process can be applied to a software design or algorithm, to implement a fully automated and self-service software platform to create, manage and publish digital coupons, weekly ads and discount deals on a web site or mobile application.

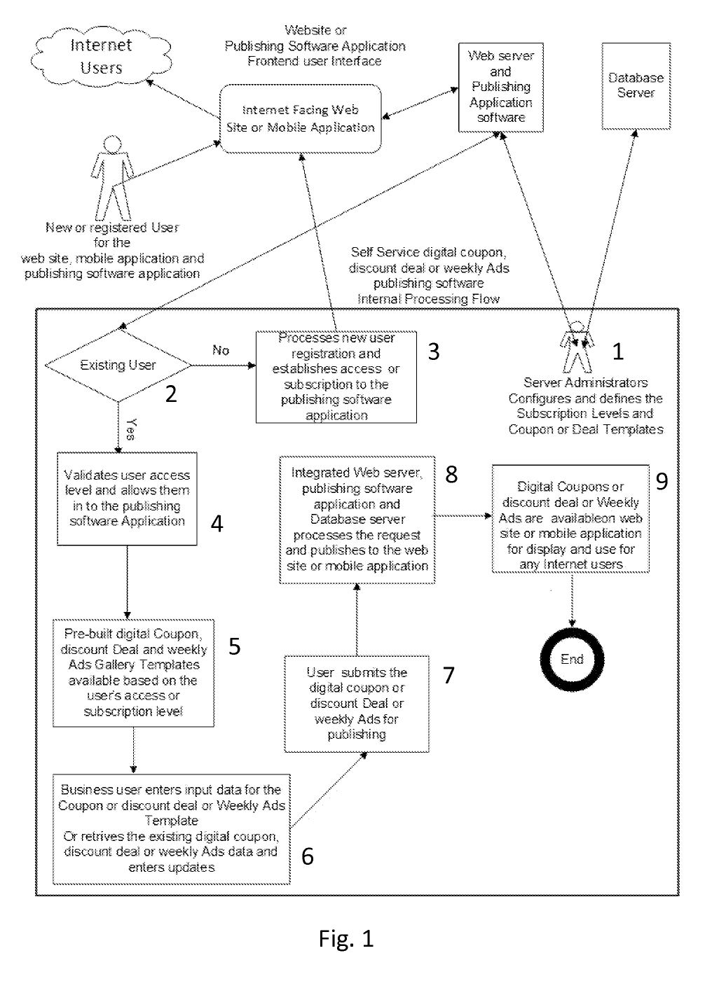

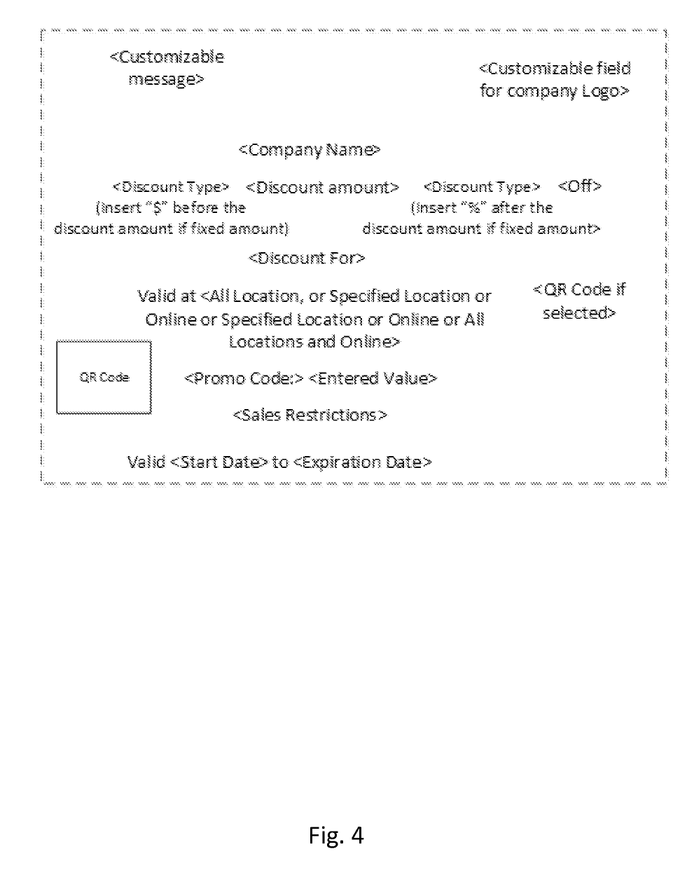

With reference to FIG. 1 the end-to-end integrated system design implementation components for the application of the method or process is shown. An integrated web server, publishing software application and database need to be established for the user requested processing. It also shows the publishing software design logic based in accordance with the invention's method or process, and how the publishing software application processes the user requests. It is a real world computer system architecture implementation of the invention method or process. As shown in the diagram, system components consist of a web server, the publishing software application and a database. All components can be built using standard web technologies. The web server is built using any standard web server software technology (i.e. Microsoft IIS, Apache.) The publishing software application is custom software that needs to be developed as a computer code or program using any standard web development language (HTML, Java, .Net or PHP.) The database server is built using any standard database software technology (i.e. Microsoft SQL, Oracle, or MySQL.) The web server and software publication processing runs on the web server. The database runs on the database server. The publishing software is the central part of the application, where the invented method and process is used as software design logic. It needs to be custom developed and is not available in the existing market. However, it is developed using the standard web development technologies available on the market. The publishing software application uses the database server to define the pre-built digital coupon, discount deal and weekly ads templates. The fields are both standard and user customizable. Standard fields are where the user enters their information in a pre-defined format. Customizable fields are where the user enters their unique information. In this case, the user is generating digital coupons, discount deals or weekly ads for a company. The field description and definition will be detailed later as a part of FIG. 4 through FIG. 6. To develop the custom publishing software, using the invention method or process as the software design logic or algorithm, the software must be developed in modular form. As shown in FIG. 1, there are 9 steps. Each step performs either a partial or full step of the invention claim for computer system processing, along with the integrated standard web and database server software. Detailed software design logic and applied invention methods are supplied below:

Step 1 performs the system configuration and setup. The user access level and pre-defined templates are defined using this step. This step allows the system operator or administrator of the system to configure one or more user access levels and pre-build templates associated with them. So a user with a certain access level will have pre-defined digital coupon, discount deal and weekly ad template galleries available to them when they login. The total number of access levels and associated pre-defined templates must be defined as part of the custom publishing software development. If the total number of access levels and associated pre-built template galleries needs to increase or decrease, the custom publishing software program or code must be updated.

Step 2 performs the user validation and checks to see if the user visiting the web site or mobile application and attempting to login to the system is a new or existing user. If the visitor is a valid existing user of the publishing software application, it will allow them access and route them to Step 4. If the visitor is a new user, it will route them to Step 3 to sign up and establish valid credentials, a User ID and password, for the digital coupon, discount deal and weekly ad publishing software application. If a user already has a valid User ID and password on the system, Step 1 routes them Step 4.

Step 3 allows a user to register on the system by supplying the required user specific information set forth by publishing software application. This step processes new user registrations and establishes their access levels and associated pre-built digital coupon, discount deal and weekly ad template access.

Step 4 validates the user access level and grants access to the software application and associated pre-built digital coupon, discount deal or weekly ad template repository.

Step 5 presents the available digital coupon, discount deal and weekly ad template galleries to the user, based on their access or subscription level.

Step 6 allows a user to enter new digital coupon, discount deal or weekly ad content data for both standard and customizable fields of the pre-built templates. If the user is updating an existing digital coupon, discount deal or weekly ad, it also allows them to retrieve existing images and update both standard and customizable field contents. This software step processes the entry of both new digital coupon, discount deal or weekly ad creation or content updates for ones that already exist.

Step 7 allows the user to submit content for new digital coupon, discount deal or weekly ad creation. It also handles content update submission for existing digital coupons, discount deals or weekly ads. This step allows submission for both the invention claim methods and processes.

Step 8 publishes the digital coupon, discount deal or weekly ad, whether a new creation or content update, by routing the request to the database server and web server. The database server processes the request and updates the database. The web server processes the request and publishes the coupon, discount deal or weekly ad to the web site or mobile application.

Step 9 is where the web server displays the newly created digital coupon, discount deal or weekly ad, or content update of an existing one, to the web site or mobile application. The newly created digital coupon, discount deal or weekly ad is visible to any internet users when they visit the web site or mobile application.

FIG. 1 illustrates the end-to-end method or process for establishing a digital coupon, discount deal and weekly ad publishing system, consisting of a web server, database server and publishing software application. It also illustrates the software design logic and user request processing for the custom publishing software application development, based on the claimed invention method or process. Step 1 software code can be updated to add additional pre-build template galleries to the established publishing system, and updates the existing pre-build template galleries to add additional fields. This is the method used for customizing the existing pre-built templates after the initial setup or adding news ones later. Any updates to the software code or program for Step 1 are presented and processed by Steps 4 through 8.

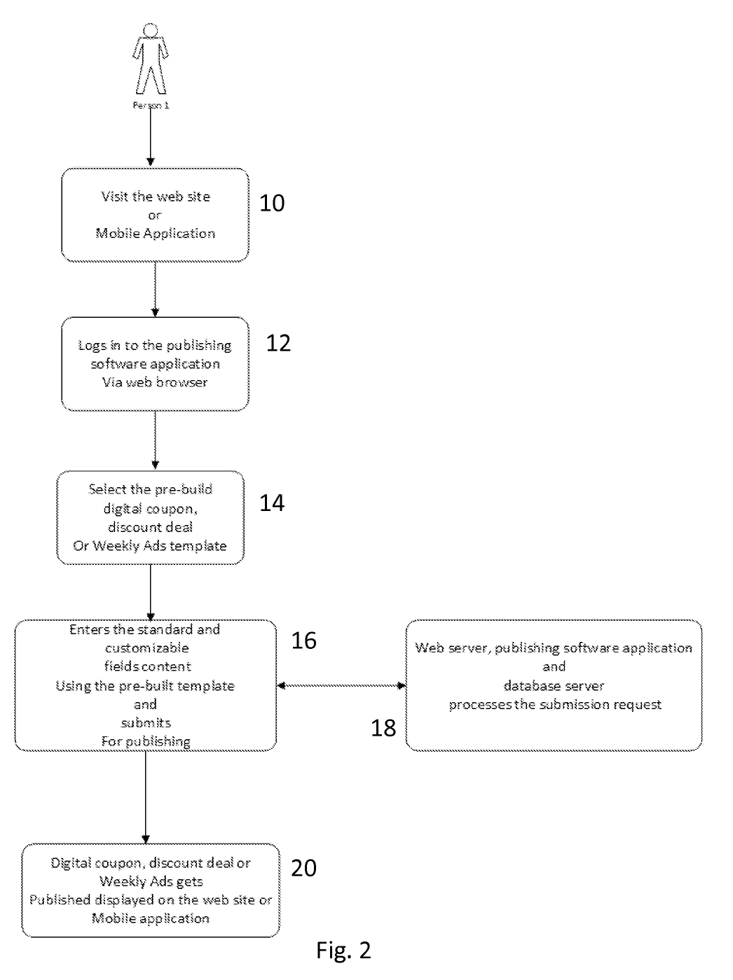

In an embodiment, FIG. 2 shows the digital coupon, discount deal or weekly ad creation method or process, which takes place after establishing the publishing system shown in FIG. 1. As shown in the diagram, in step 10 a user visits the web site and in step 12 logs in to the publishing application via any standard web browser. In step 14 the user is then presented with the pre-built digital coupon, discount deal and weekly ad gallery templates. In step 16 the user enters the content for both standard and customizable fields of the pre-built templates, and submits them for publishing. Upon submission, in step 18 the integrated web server, publishing software application and database server process the submitted request and in step 20 immediately displays the digital coupon, discount deal or weekly ad on the web site or mobile application.

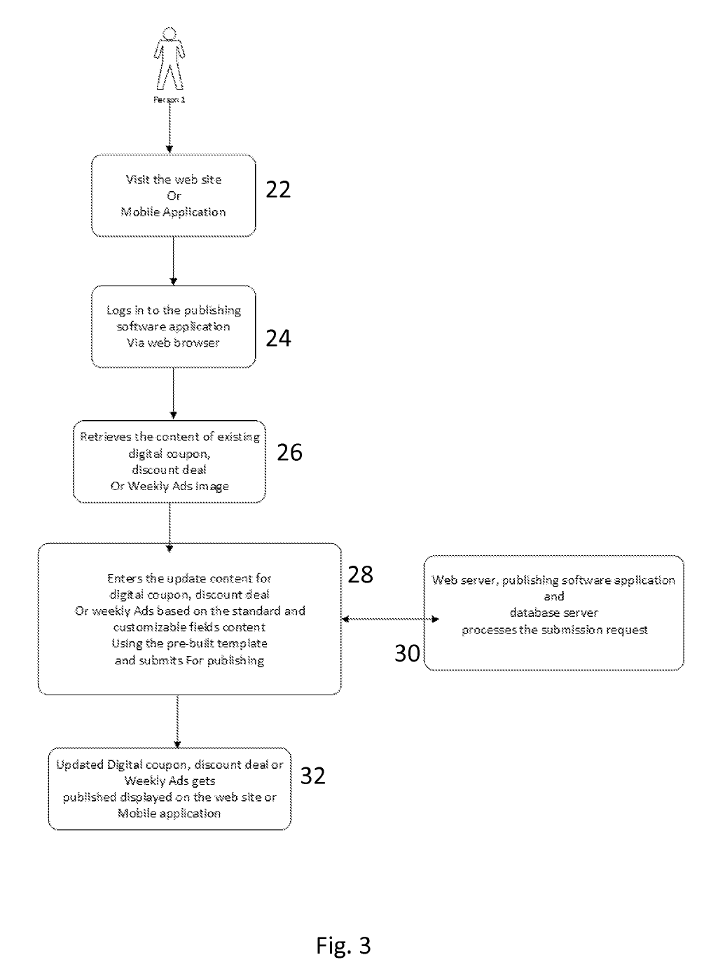

In an embodiment, FIG. 3 shows the digital coupon, discount deal or weekly ad management method or process after establishing the publishing system shown in FIG. 1. As shown in the diagram, in step 22 a user visits the web site and in step 24 logs in to the publishing application via any standard web browsers. In step 26 the user then retrieves the existing digital coupon, discount deal or weekly ad and enters the content update via the web browser. In step 28 the user can enter content updates for both standard and customizable fields, based on the pre-built templates, and submit them for publishing. Upon submission, in step 30 the integrated web server, publishing software application and database server process the submitted request and in step 32 immediately display the updated digital coupon, discount deal or weekly ad on the web site or mobile application.

FIG. 4 shows the layout, standard fields and customizable fields of a pre-built digital coupon template. This demonstrates the practical application of the claimed method or processes. The total number of fields shown in FIG. 4 can be adjusted to increase or decrease by updating the publishing software code or program, in FIG. 1. Below are the sample field descriptions for each field.
Company Name: (User types in their company name)
Customizable message text: (User types in any text)
Discount Type: (Drop down list—user selects one of the following options)
   Fixed Amount
   Percentage Based
   Free
Discount For: (Drop down list—user selects one of the following options)
   Total Purchase
   Specific Item
   (If they select “Specific Item,” another field opens with the field name “Item Name,” where they type in the name of the item.)
Item Name: (User types in name of the item if “Specific Item” was selected above.)
Location: (Drop down list—user selects one of the following options)
   All Locations
   Specific Locations
   Online
   All Locations and Online
   Specific Locations and Online
   (If they select “Specific Locations” or “Specific Locations and Online,” another field opens with the field name “Specific Locations,” where they type in the location name(s), i.e. Location A, Location B etc.)
Specific Locations: (User types in if “Specific Locations” was selected above)
Promo Code: (User types in if they want to use a promo code. If they don't type anything, the field stays blank.)
Sales Restrictions: (User types in any offer restrictions they may have)
Start Date: (User selects this from the calendar that appears)
Expiration Date: (User selects this from the calendar that appears)
Logo: (User can upload a company logo. If they don't supply a logo, it stays blank.)
QR Code: (Drop down list—user selects one of the following)
   Yes
   No
   (If they select “Yes,” the QR code is inserted into the designated area of the digital coupon template when they publish it. If they select “No,” the space is left blank.)

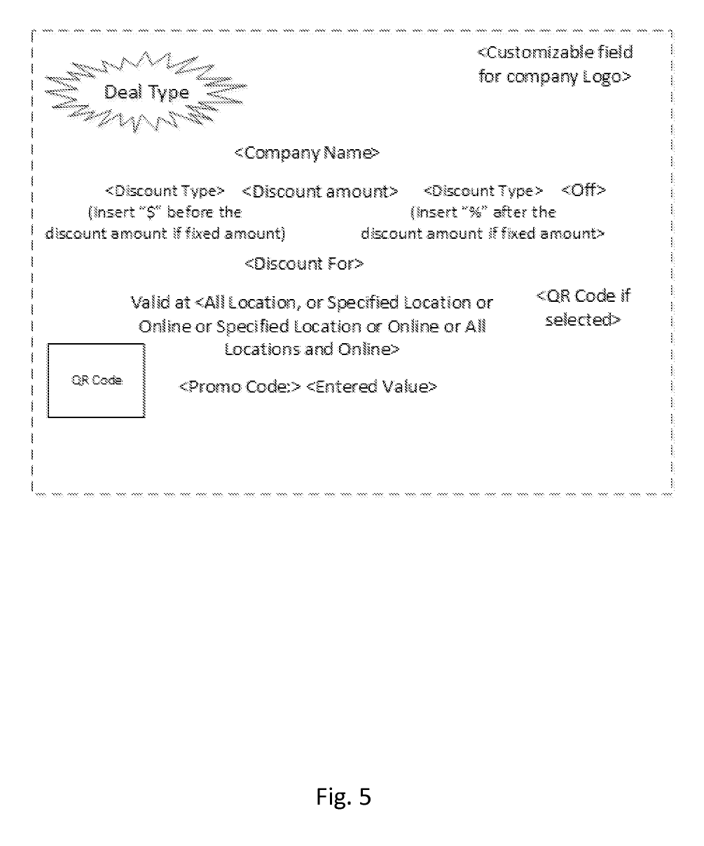

FIG. 5 shows the layout, standard fields and customizable fields of a pre-built digital discount deal template. This demonstrates the practical application of the claimed method or processes. The total number of fields shown in FIG. 5 can be adjusted to increase or decrease by updating the publishing software code or program, in FIG. 1. Below are the field descriptions for each field.
Company Name: (User types in their company name.)
Deal Type: (Drop down list—user selects from the following options)
   Daily
   Weekly
   Yearly
Discount Type: (Drop down list—user selects from one of the following options)
   Fixed Amount
   Percentage Based
   Free
Discount For: (Drop down list—user selects from the following options)
   Total Purchase
   Specific Item
   (If they select “Specific Item,” another field opens up with the field name “Item Name,” where they type in the name of the item)
Item Name: (User types in name of the item if “Specific Item” was selected above)
Location: (Drop down list—user selects one of the following options)
   All Locations
   Specific Locations
   Online
   All Locations and Online
   Specific Locations and Online
   (If they select “Specific Locations” or “Specific Locations and Online,” another field opens with the field name “Specific Locations,” where they type in the location name(s), i.e. Location A, Location B etc.)
Specific Locations: (User types in if “Specific Locations” was selected above)
Promo Code: (User types in if they want to use a promo code. If they don't type anything, the field stays blank.)
Sales Restrictions: (User types in any offer restrictions they may have)
Start Date: (User selects this from the calendar that appears)
Expiration Date: (User selects this from the calendar that appears)
Logo: (User can upload a company logo. If they don't supply a logo, it stays blank.)
QR Code: (Drop down list—user selects from the following)
   Yes
   No
   (If they select “Yes,” the QR code is inserted into the designated area of the digital discount deal template when they publish it. If they select “No,” the space is left blank.)

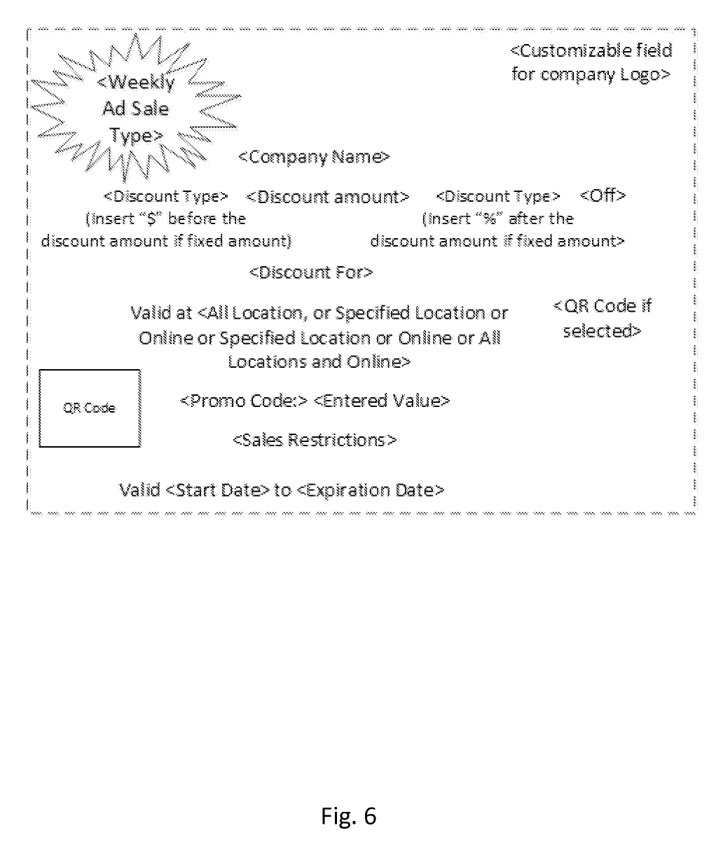

FIG. 6—shows the layout, standard fields and customizable fields of a pre-built digital weekly ad template that is configured by the publishing software's Step 1 in FIG. 1. This demonstrates the practical application of the claimed method or processes. The total number of fields shown in FIG. 6 can be adjusted to increase or decrease by updating the publishing software code or program, in FIG. 1. Below are the field description for each field.
Company Name: (User Types in their company name.)
Weekly Ads Sale Type: (Drop down list—user selects from the following options)
   Sale
   Special
Discount Type: (Drop down list—user selects from one of the following options)
   Fixed Amount
   Percentage Based
   Free
Discount For: (Drop down list—user selects from the following options)
   Total Purchase
   Specific Item
   (If they select “Specific Item,” another field opens up with the field name “Item Name,” where they type in the name of the item)
Item Name: (User types in name of the item if “Specific Item” was selected above)
Location: (Drop down list—user selects from the following options)
   All Locations
   Specific Locations
   Online
   All Locations and Online
   Specific Locations and Online
   (If they select “Specific Locations” or “Specific Locations and Online,” another field opens with the field name “Specific Locations,” where they type in the location name(s), i.e. Location A, Location B etc.)
Specific Locations: (User types in if “Specific Locations” was selected above)
Promo Code: (User types in if they want to use a promo code. If they don't type anything, the field stays blank.)
Sales Restrictions: (User types in any offer restrictions they may have)
Start Date: (User selects this from the calendar that appears)
Expiration Date: (User selects this from the calendar that appears)
Logo: (User can upload a company logo. If they don't supply any logo, it stays blank.)
QR Code: (Drop down list—user selects from the following)
   Yes
   No
   (If they select “Yes,” the QR code is inserted into the designated area of the digital weekly ad template when they publish it. If they select “No,” the space is left blank.)

The claimed invention method or process for self-service creation and management of digital coupons, discount deals and weekly ads are clearly and distinctly demonstrating practical use in FIG. 1 through FIG. 6.

Demonstrated figures show the practical application and usage of the claimed method or process and how it is unique and not available with any existing system. As mentioned in the background of the invention, existing methods require usage of multiple software applications, software compatibility, and human validation of image proofs through human interaction by multiple parties. The claimed method or process, as applied and built using available standard web technologies, creates an end-to-end solution with a single user performing the steps and publishing it instantly to a web site or mobile application for immediate use. Each user has full control of creating and/or managing their digital coupons, discount deals and/or weekly ads. The claimed method or process provides a distinct digital coupon, discount deal and weekly ad publishing platform that eliminates significant time, cost human interaction and room for error. It is a uniquely more efficient model than any that currently exists.

1. A method of publishing and creating a self-service digital promotional advertisement, comprising the steps of:
a. validating a user access and permitting entry to a publishing application;
b. providing a pre-built digital promotional advertisement and template based on the user's access;
c. the user inputting data for the promotional advertisement and template;
d. the user submitting the promotional advertisement for publishing;
e. the publishing application publishing the promotional advertisement to a web site; and
f. displaying the promotional advertisement for a user.

2. The method of claim 1, wherein the promotional advertisement is a digital coupon.

3. The method of claim 1, wherein the promotional advertisement is a discount deal.

4. The method of claim 1, wherein the promotional advertisement is a weekly ad.

5. A method of publishing and managing a self-service digital promotional advertisement, comprising the steps of:
a. visiting a web site;
b. logging into a publishing application;
c. selecting an existing published promotional advertisement;
d. customizing the promotional advertisement with updated content;
e. submitting the user-edited updated promotional advertisement for publishing;
f. the publishing application processing the submission request; and
g. publishing the user-edited updated promotional advertisement.

6. The method of claim 5, wherein the promotional advertisement is a digital coupon.

7. The method of claim 5, wherein the promotional advertisement is a discount deal.

8. The method of claim 5, wherein the promotional advertisement is a weekly ad.
